(19) United States
(12) Patent Application Publication
(10) Pub. No.: US 2010/0111009 A1
(43) Pub. Date: May 6, 2010

(54) DOWNLINK SIGNALING FOR CLOSED LOOP ANTENNA SELECTION

(75) Inventors: Kari Pekka Pajukoski, Oulu (FI); Kari Juhani Hooli, Oulu (FI); Esa Tapani Tiirola, Kempele (FI); Klaus Hugl, Helsinki (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/532,770

(22) PCT Filed: Mar. 19, 2008
(86) PCT No.: PCT/IB2008/000659

§ 371 Date: Sep. 23, 2009

Related U.S. Application Data
(60) Provisional application No. 60/919,974, filed on Mar. 26, 2007.

(51) Int. Cl. H04W 72/04

(52) U.S. Cl. 370/329

(57) ABSTRACT

Disclosed herein is a method, apparatus and computer program associated with a user equipment. The method includes determining a characteristic related to a receipt of a resource allocation in a particular subframe and, based on the determined characteristic, selecting one of a plurality of transmit antennas for use in transmitting to a wireless network node. A wireless network node that is configurable to operate with the user equipment to signal the resource allocation of the indication of the transmit antenna to be used is also disclosed.

### TECHNICAL FIELD

The exemplary and non-limiting embodiments of this invention relate generally to wireless communication systems, methods, devices and computer programs and, more specifically, relate to techniques for use with closed-loop antenna selection and related signaling.

### BACKGROUND

Various abbreviations that appear in the specification and/or in the drawing figures are defined as follows:

3GPP third generation partnership project

UTRAN universal terrestrial radio access network

Node B base station

UE user equipment

EUTRAN evolved UTRAN

aGW access gateway

eNB EUTRAN Node B (evolved Node B)

LTE long term evolution

CQI channel quality indicator

OFDMA orthogonal frequency division multiple access

SC-FDMA single carrier, frequency division multiple access

UL uplink

DL downlink

ASTD antenna selection transmit diversity

CL closed loop

RS reference signal

FDD frequency division duplex

TFI transport format indicator

MCS modulation coding scheme

A proposed communication system known as evolved UTRAN (E-UTRAN, also referred to as UTRAN-LTE or as E-UTRA) is under discussion within 3GPP. The current working assumption is that the DL access technique will be OFDMA, and the UL access technique will be SC-FDMA.

One specification of interest to the to the exemplary embodiments of this invention is 3GPP TS 36.300, V8.3.0 (2007-12), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8), which is incorporated by reference herein in its entirety.

In 3GPP several discussions have taken place related to transmit antenna diversity in the UL. Reference in this regard may be had to, for example:

3GPP TSG RAN WG1 Meeting #47bis, Sorrento, Italy, Jan. 15-19, 2007, R1-070097,

“Performance Evaluation of Closed Loop-Based Antenna Switching Transmit Diversity in E-UTRA Uplink”, NTT DoCoMo;

3GPP TSG RAN WG1 Meeting #47bis, Sorrento, Italy, Jan. 15-19, 2007, R1-070103, “Downlink L1/L2 Control Signaling Channel Structure: Coding”, NTT DoCoMo, Fujitsu, KDDI, Mitsubishi Electric, NEC; and

3GPP TSG RAN WG1 Meeting #48, St. Louis, USA, Feb. 12-16, 2007, R1-070860, “Closed Loop Antenna Switching in E-UTRA Uplink”, NTT DoCoMo, Institute for Infocomm Research, Mitsubishi Electric, NEC, Sharp, Toshiba Corporation.

It has been determined that a CL-type of adaptive ASTD should be supported as a UE capability for FDD and half duplex FDD.

In order to enable frequency domain packet scheduling, as well as adaptation of antenna selection, the UL transmission of a sounding RS may be periodically alternated between the possible transmission antennas. The period between sounding RS transmissions is one subframe at a minimum, but it may also be longer.

By definition, the antenna selection is to be signaled in some manner on the DL to the UE when CL ASTD is used. As may be appreciated, this approach requires the design of a suitable DL signaling scheme.

In at least one previously presented DL signaling scheme proposal an additional bit is used for indicating the antenna selection in the UL scheduling grant. Reference in this regard can be made to the above-cited R1-070860, “Closed Loop Antenna Switching in E-UTRA Uplink”, NTT DoCoMo et al. This additional bit is added to the basic scheduling grant, requiring the introduction of an additional UL scheduling format or, alternatively, an existing bit in the UL scheduling grant is proposed to be re-used for the antenna selection indication. In the latter option, the interpretation of the UL scheduling grant is changed and, thus, the signaling capabilities are reduced, e.g., for TFI, MCS, or other information included in the scheduling grant. As can be appreciated, the addition of another bit to the DL signaling can be disadvantageous for a number of reasons.

### SUMMARY

The foregoing and other problems are overcome, and other advantages are realized, by the use of the exemplary embodiments of this invention.

In a first aspect the exemplary embodiments of this invention provide a method that includes determining a characteristic related to a receipt of a resource allocation in a particular subframe; and based on the determined characteristic, selecting one of a plurality of transmit antennas for use in transmitting to a wireless network node.

In another aspect the exemplary embodiments of this invention provide a computer-readable medium that stores computer program instructions, the execution of which result in operations that comprise determining a characteristic related to a receipt of a resource allocation in a particular subframe; and based on the determined characteristic, selecting one of a plurality of transmit antennas for use in transmitting to a wireless network node.

In another aspect the exemplary embodiments of this invention provide an apparatus that includes at least one wireless receiver to receive a resource allocation from a wireless network node and a controller configurable to determine a characteristic related to a receipt of a resource allocation in a particular subframe and, based on the determined characteristic, to select one of a plurality of transmit antennas for use in transmitting to the wireless network node.

In another aspect the exemplary embodiments of this invention provide a method that includes receiving during subframes reference signals transmitted from different ones of a plurality of transmit antennas of a user equipment; and signaling to the user equipment an identification of one of the plurality of transmit antennas to be used for a next transmission. Signaling comprises selecting the transmit antenna based at least on the received reference signals, withholding sending a resource allocation to the user equipment during a particular subframe, sending a resource allocation to the user equipment during a next consecutive subframe for indicating to the user equipment to use the transmit antenna that corresponds to the transmit antenna on which the reference signal was last transmitted before the particular subframe.

In a further aspect the exemplary embodiments of this invention provide an apparatus that includes at least one transmitter and at least one receiver; and that further includes a controller coupled with the at least one transmitter and the at least one receiver. The controller is configurable in response to reference signals received from different ones of a plurality of transmit antennas of a user equipment to signal to the user equipment an identification of one of the plurality of transmit antennas to be used for a next transmission. The controller selects the transmit antenna based at least on the received reference signals, and is further configurable to withhold transmitting a resource allocation to the user equipment during a particular subframe, to transmit a resource allocation to the user equipment during a next consecutive subframe to indicate to the user equipment to use the transmit antenna that corresponds to the transmit antenna on which the reference signal was last transmitted before the particular subframe.

In a still further aspect the exemplary embodiments of this invention provide a method that comprises receiving during subframes reference signals transmitted from different ones of a plurality of transmit antennas of a user equipment; and signaling to the user equipment an identification of one of the plurality of transmit antennas to be used for a next transmission, where signaling comprises selecting the transmit antenna based at least on the received reference signals and transmitting a resource allocation to the user equipment in a particular subframe, where the number of the particular subframe specifies which one of the plurality of transmit antennas is to be used by the user equipment for a next transmission.

In yet another aspect the exemplary embodiments of this invention provide an apparatus having at least one transmitter and at least one receiver, and further having a controller coupled with the at least one transmitter and the at least one receiver. The controller is configurable in response to reference signals received from different ones of a plurality of transmit antennas of a user equipment to signal to the user equipment an identification of one of the plurality of transmit antennas to be used for a next transmission. The controller selects the transmit antenna based at least on the received reference signals and is further configurable to transmit a resource allocation to the user equipment in a particular subframe, where the number of the particular subframe specifies which one of the plurality of transmit antennas is to be used by the user equipment for a next transmission.

### BRIEF DESCRIPTION OF THE DRAWINGS

In the attached Drawing Figures:

FIG. 1 illustrates closed loop antenna selection with the timing of an UL scheduling grant.

FIG. 2 illustrates a change of transmit antenna with DL signaling based on the timing of the UL scheduling grant.

FIG. 3 is a logic flow diagram that illustrates the operation of a method, and a result of execution of computer program instructions, and is descriptive of the operation of a UE transmit antenna selection logic in accordance with a first embodiment of this invention.

FIG. 4 shows a simplified block diagram of various electronic devices that are suitable for use in practicing the exemplary embodiments of this invention.

FIG. 5 shows in greater detail a part of the UE of FIG. 4.

FIG. 6 is a logic flow diagram that illustrates the operation of a method, and a result of execution of computer program instructions, and is descriptive of the operation of the UE transmit antenna selection logic in accordance with another embodiment of this invention.

### DETAILED DESCRIPTION

Disclosed herein is a technique to perform DL signaling for CL antenna selection in the UL, where the technique does not introduce additional signaling overhead and does not require any changes to, or place any limitations on, an UL scheduling grant.

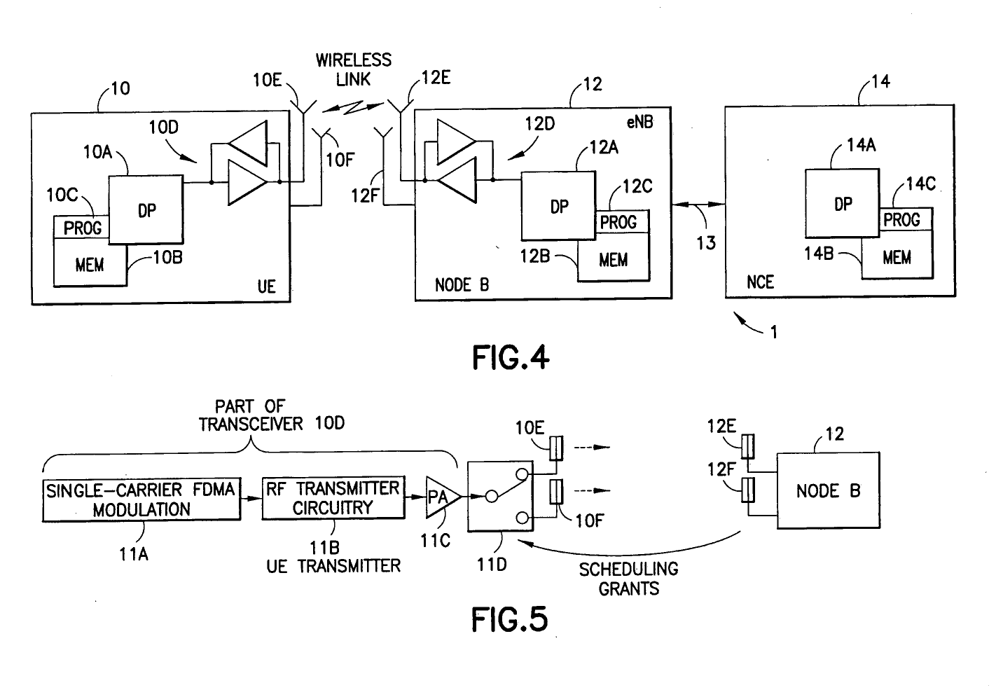

Reference is made first to FIG. 4 for illustrating a simplified block diagram of various electronic devices that are suitable for use in practicing the exemplary embodiments of this invention. In FIG. 4 a wireless network 1 is adapted for communication with a first apparatus, such as a UE 10, via a second apparatus, such as a Node B (base station) 12, which may also be referred to as an eNB 12 herein. The network 1 may include a network control element (NCE) 14, such as an aGW. The UE 10 includes a controller such as one embodied by at least one data processor (DP) 10A, a memory (MEM) 10B that stores a program (PROG) 10C, and a suitable radio frequency (RF) transceiver 10D for bidirectional wireless communications with the Node B 12. For the purposes of describing the exemplary embodiments the UE 10 is assumed to include at least two transmit (Tx) antennas 10E, 10F. The Node B 12 also includes a controller such as one embodied by at least one DP 12A, a MEM 12B that stores a PROG 12C, a suitable RF transceiver 12D and typically also a plurality (at least two) of antennas 12E, 12F. The Node B 12 is coupled via a data path 13 to the NCE 14 that also includes a DP 14A and a MEM 14B storing an associated PROG 14C. As will be made apparent below, the PROGs 10C and 12C are each assumed to include program instructions that, when executed by the associated DP, enable the electronic device to operate in accordance with the exemplary embodiments of this invention.

In general, the exemplary embodiments of this invention may be implemented at least in part by computer software executable by the DP 10A of the UE 10 and by the DP 12A of the Node B 12, or by hardware, or by a combination of software and hardware (and firmware).

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, flash memory, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

The exemplary embodiments of this invention may be used in the system 1 of FIG. 4 to link an indication of a selected one of the transmit antennas 10E, 10F to a subframe in which the UE 10 receives the first scheduling grant indicating a start of resource allocation. As employed herein, the “first” scheduling grant or start of resource allocation is meant to imply that the UE 10 did not receive a scheduling grant in the previous subframe, it being noted that the UE 10 may typically receive scheduling grants in a plurality of consecutive subframes. In general, the resource allocation or scheduling grant transmitted to the UE 10 is for new data, as opposed to one related to a retransmission.

In accordance with the exemplary embodiments of this invention, the Node B 12 signals the selection of the transmit antenna 10E, 10F by beginning a resource allocation for the UE 10 in a subframe corresponding to the selected one of the antennas 10E, 10F. The antenna selection remains unchanged as long as the UE 10 has resource allocations in the consecutive subframes.

There are several possible embodiments to logically link a transmit antenna to a scheduling grant for a particular subframe, including (as non-limiting examples):

A. the scheduling grant for a subframe indicates also the use of Tx antenna 10E, 10F from which a latest sounding RS was transmitted; and

B. the scheduling grant for even subframes indicates the Tx antenna 1 (e.g., Tx antenna 10E), and a scheduling grant sent in an odd subframe indicates Tx antenna 2 (e.g., Tx antenna 10F).

Tx antenna 1 and 2 may be seen as logical values, and association between even/odd subframe and physical Tx antennas can be done with RRC signaling. Alternatively, the UE 10 may randomly associate Tx antenna 1 and 2 to physical Tx antennas during the initialization of closed loop antenna selection operation mode.

Note that embodiment B allows for a shorter delay than the embodiment A, when the period of the sounding RS is two subframes or more.

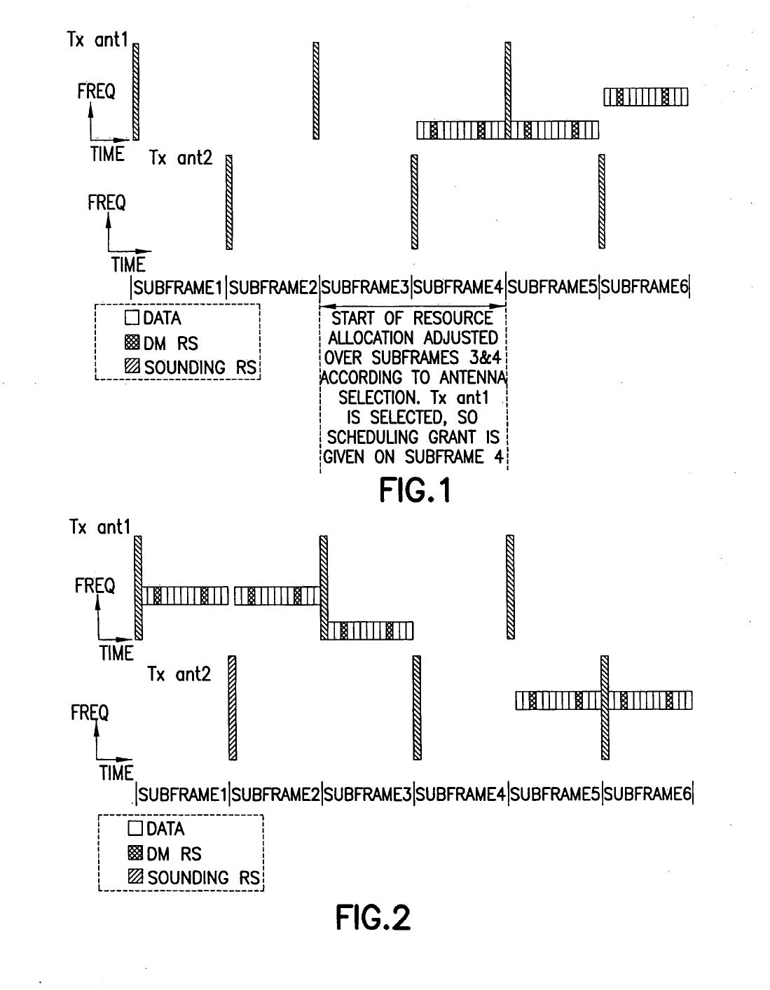

In the following description of FIGS. 1, 2 and 3 the use of the first embodiment (A) and a sounding RS period of one subframe are assumed for convenience, and not as a limitation. The sounding RS may be assumed to be transmitted from Tx antenna 1 in odd subframes and from Tx antenna 2 in even subframes. Thus, resource allocations starting in even subframes indicate the use of Tx antenna 1 while resource allocations starting in odd subframes indicate the use of Tx antenna 2. A start of resource allocation is illustrated in FIG. 1, and a change of transmit antenna is illustrated in FIG. 2. In the example in FIG. 2 the Node B 12 makes a determination to change the UE 10 antenna to Tx antenna 2 after receiving the sounding RS in subframe 2. It is assumed that the Node B 12 also determines to minimize the gap in the UE 10 transmissions and, thus, assigns a scheduling grant to the UE 10 also for subframe 3. The change of transmit antenna is indicated by the lack of a scheduling grant for subframe 4, and the presence of the scheduling grant for subframe 5. Note that the resource allocations starting in even subframes indicate the use of Tx antenna 1 while resource allocations starting in odd subframes indicate the use of Tx antenna 2 in FIGS. 1 and 2, however alternatively they can be seen to illustrate the use of second embodiment (B).

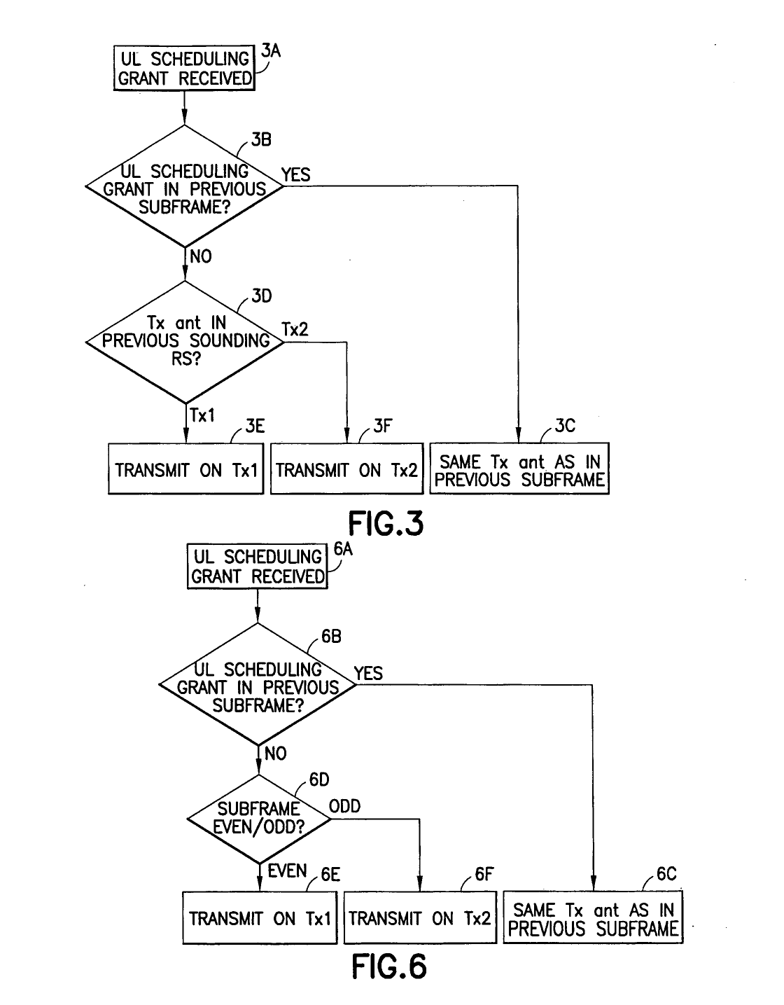

A logic flow diagram of one embodiment of the antenna selection logic in the UE 10 is shown in FIG. 3. At Block 3A the UE 10 receives a scheduling grant, and at Block 3B makes a determination if a scheduling grant was received in the previous subframe. If yes, control passes to Block 3C to use the same TX antenna 10E or 10F as in the previous subframe (i.e., no Tx antenna change has been indicated by the Node B 12). However, if an UL scheduling grant was not received in the previous subframe, control passes instead to Block 3D to determine which antenna (Tx1 or Tx2) was used by the UE 10 in the previous sounding RS. If Tx1 was used for the previous sounding RS, then control passes to Block 3E to use Tx1 for the next UL transmission, while if Tx2 was used then control passes to Block 3F to use Tx2 for the next UL transmission.

A logic flow diagram of another embodiment of the antenna selection logic in the UE 10 is shown in FIG. 6. At Block 6A the UE 10 receives a scheduling grant, and at Block 6B makes a determination if a scheduling grant was received in the previous subframe. If yes, control passes to Block 6C to use the same TX antenna 10E or 10F as in the previous subframe (i.e., no Tx antenna change has been indicated by the Node B 12). However, if an UL scheduling grant was not received in the previous subframe, control passes instead to Block 6D to determine the subframe number of the received scheduling grant. If the subframe number is even, then control passes to Block 6E to use Tx1 for the next UL transmission, while if subframe number is odd then control passes to Block 6F to use Tx2 for the next UL transmission. Note that there may be a decision block following block 6A where the UE 10 first determines if there is a retransmission, and if yes then control passes to a block that uses same Tx antenna as in the first transmission.

The various blocks shown in FIGS. 3 and 6 may be viewed as method steps, and/or as operations that result from operation of computer program code, and/or as a plurality of coupled logic circuit elements constructed to carry out the associated function(s).

FIG. 5 shows a portion of the UE 10 and the Node B 12. The UE 10 transmitter can be considered, in a non-limiting embodiment, to include a block 11A for performing SC-FDMA modulation, a block 11B containing the RF transmitter circuitry, and a power amplifier (PA) 11C. Between the PA 11C and the Tx antenna 10E, 10F is an antenna selection logic block 11D, shown schematically as a switch, for directing the output of the PA 11C to either Tx antenna 10E or Tx antenna 10F. The switch 11D is controlled by the UE 10 in accordance with the presence/absence of scheduling grants, as shown in FIG. 3, or in accordance with the presence/absence of scheduling grants and subframe number (e.g., odd or even) in which first scheduling grant was received, to select one of Tx antenna 10E or Tx antenna 10F for use during a next UL transmission. The presence of scheduling grants (and possibly the absence of same) from the Node B 12 can be seen to close the antenna selection loop with the UE 10.

The use of the exemplary embodiments of this invention beneficially allow for closed loop antenna selection without: (a) increasing the signaling overhead in the DL, (b) or requiring an introduction of a new UL scheduling grant format, or (c) requiring a reduction in the information content in the UL scheduling grant for, as non-limiting examples, TFI and/or MCS.

Based on the foregoing description it should be appreciated that these exemplary embodiments provide in one aspect thereof a method, computer program and apparatus that are configurable to determine a characteristic related to a receipt of a resource allocation in a particular subframe and, based on the determined characteristic, to select one of a plurality of transmit antennas for use in transmitting to a wireless network node.

Based on the foregoing it should be apparent that the exemplary embodiments of this invention provide a method to operate a UE by determining a selection of a transmit antenna from a plurality of transmit antennas in response to a subframe timing of a resource allocation made to the UE, where the antenna selection is performed by the UE only if a resource allocation was not received by the UE in a previous consecutive subframe.

The method of the preceding paragraph, where the resource allocation is a scheduling grant received from a Node B.

The method of the preceding paragraphs, where the UE selects a transmit antenna that corresponds to the transmit antenna on which a sounding reference signal was last sent to the Node B.

In the preceding paragraphs the resource allocation is a resource allocation for new data.

Based on the foregoing it should be apparent that the exemplary embodiments of this invention also provide a computer program the execution of which operates a UE by determining a selection of a transmit antenna from a plurality of transmit antennas in response to a subframe timing of a resource allocation made to the UE, where the antenna selection is performed by the UE only if a resource allocation was not received by the UE in a previous consecutive subframe.

The computer program of the preceding paragraph, where the resource allocation is a scheduling grant received from a Node B.

The computer program of the preceding paragraphs, where the UE selects a transmit antenna that corresponds to the transmit antenna on which a sounding reference signal was last sent to the Node B.

In the preceding paragraphs the resource allocation is a resource allocation for new data.

Based on the foregoing it should also be apparent that the exemplary embodiments of this invention provide a UE comprising a controller to determine a selection of one transmit antenna from at least two transmit antennas in response to a subframe timing of a resource allocation made to the UE, where the antenna selection is performed only if a resource allocation was not received by the UE in a previous consecutive subframe.

The UE of the preceding paragraph, where the resource allocation is a scheduling grant received from a Node B.

The UE of the preceding paragraphs, where the controller is configured to select a transmit antenna that corresponds to the transmit antenna on which a sounding reference signal was last transmitted to the Node B.

Based on the foregoing it should be also apparent that the exemplary embodiments of this invention provide a communication device that comprises means for receiving a resource allocation and means for selecting a transmit antenna from a plurality of transmit antennas in response to a subframe timing of the received resource allocation, where the means for selecting operates only if a resource allocation was not received by the UE in a previous consecutive subframe.

The communication device of the preceding paragraph, where the resource allocation comprises a scheduling grant received from a Node B.

The communication device of the preceding paragraphs, where the selecting means selects a transmit antenna that corresponds to the transmit antenna on which a sounding reference signal was last transmitted.

Based on the foregoing it should be further apparent that the exemplary embodiments of this invention provide a method to operate a Node B to signal a UE an identification of one of a plurality of transmit antennas to be used by selecting the transmit antenna based at least on sounding reference signals received from the UE from different ones of the plurality of transmit antennas, to withhold sending a resource allocation to the UE during a particular subframe and to then send a resource allocation to the UE during a next consecutive subframe for causing the UE to select to use the transmit antenna that was selected by the Node B as being the one that corresponds to the transmit antenna on which the sounding reference signal was last transmitted by the UE to the Node B.

The method of the preceding paragraph, where the resource allocation is a scheduling grant transmitted from the Node B.

In the preceding paragraphs the resource allocation is a resource allocation for new data.

Based on the foregoing it should also be apparent that the exemplary embodiments of this invention provide a computer program the execution of which operates a Node B to signal a UE an identification of one of a plurality of transmit antennas to be used by selecting the transmit antenna based at least on sounding reference signals received from the UE from different ones of the plurality of transmit antennas, to withhold sending a scheduling grant to the UE during a particular subframe and to then send a scheduling grant to the UE during a next consecutive subframe for causing the UE to select to use the transmit antenna that was selected by the Node B as being the one that corresponds to the transmit antenna on which the sounding reference signal was last transmitted by the UE to the Node B.

The computer program of the preceding paragraph, where the resource allocation is a scheduling grant transmitted from the Node B.

In the preceding paragraphs the resource allocation is a resource allocation for new data.

Based on the foregoing it should be further apparent that the exemplary embodiments of this invention provide a Node B that comprises antennas for transmitting and receiving signals, and a control function to signal a UE an identification of one of a plurality of transmit antennas to be used by the UE, the control function selecting the transmit antenna based at least on sounding reference signals received from the UE from different ones of the plurality of transmit antennas, to withhold sending a scheduling grant to the UE during a particular subframe and to then send a scheduling grant to the UE during a next consecutive subframe for causing the UE to select to use the transmit antenna that was selected by the Node B as being the one that corresponds to the transmit antenna on which the sounding reference signal was last transmitted by the UE to the Node B.

The Node B of the preceding paragraph, where the resource allocation is a scheduling grant transmitted from the Node B.

Based on the foregoing it should be further apparent that the exemplary embodiments of this invention provide a network device that comprises antennas for transmitting and receiving signals, and means for signaling a UE an identification of one of a plurality of transmit antennas to be used by the UE, the signaling means comprising means for selecting the transmit antenna based at least on sounding reference signals received from the UE from different ones of the plurality of UE transmit antennas, said signaling means configured for withholding the sending of a scheduling grant to the UE during a particular subframe and for then sending a scheduling grant to the UE during a next consecutive subframe for causing the UE to use as a transmit antenna one that corresponds to the transmit antenna on which the sounding reference signal was last transmitted by the UE.

The network device of the preceding paragraph, where the resource allocation is a scheduling grant.

Based on the foregoing it should also be realized that the exemplary embodiments of this invention provide a method to operate a UE by receiving a scheduling grant; and selecting a first Tx antenna for use if the scheduling grant was received in an even subframe, or selecting a second Tx antenna for use if the scheduling grant was received in an odd subframe, where the antenna selection is performed only if a scheduling grant was not received by the UE in a previous consecutive subframe.

Based on the foregoing it should also be realized that the exemplary embodiments of this invention also provide a computer program comprising instructions, the execution of which operate a UE in response to receiving a scheduling grant to select a first Tx antenna for use if the scheduling grant was received in an even subframe, or to select a second Tx antenna for use if the scheduling grant was received in an odd subframe, where the antenna selection is performed only if a scheduling grant was not received by the UE in a previous consecutive subframe.

Based on the foregoing it should also be realized that the exemplary embodiments of this invention also provide a UE that comprises a receiver configured to receive a scheduling grant, and a control function configured to select a first Tx antenna for use if the scheduling grant was received in an even subframe, or to select a second Tx antenna for use if the scheduling grant was received in an odd subframe, where the antenna selection is performed by the UE only if a scheduling grant was not received by the UE in a previous consecutive subframe.

Based on the foregoing it should also be realized that the exemplary embodiments of this invention also provide a device that comprises means for receiving a scheduling grant, and means for selecting a first Tx antenna for use if the scheduling grant was received in an even subframe, or for selecting a second Tx antenna for use if the scheduling grant was received in an odd subframe, where the antenna selection is performed only if a scheduling grant was not received by the UE in a previous consecutive subframe

Based on the foregoing it should also be realized that the exemplary embodiments of this invention provide a method to operate a Node B by selecting one of two Tx antennas to be used by a UE; withholding from sending a scheduling grant to the UE during a particular subframe and transmitting a scheduling grant to the UE in one of an odd or an even subframe for informing the UE 10 the selected one of the two Tx antennas.

Based on the foregoing it should also be realized that the exemplary embodiments of this invention also provide a computer program comprising instructions, the execution of which operate a Node B by selecting one of two Tx antennas to be used by a UE; withholding from sending a scheduling grant to the UE during a particular subframe and transmitting a scheduling grant to the UE in one of an odd or an even subframe for informing the UE 10 the selected one of the two Tx antennas.

Based on the foregoing it should also be realized that the exemplary embodiments of this invention also provide a Node B that comprises a selector configured to select one of two Tx antennas to be used by a UE; and a transmitter configured to withhold sending a scheduling grant to the UE during a particular subframe and to transmit a scheduling grant to the UE in one of an odd or an even subframe for informing the UE 10 the selected one of the two Tx antennas.

Based on the foregoing it should also be realized that the exemplary embodiments of this invention also provide a network device that comprises means for selecting one of two Tx antennas to be used by a UE; and means for withholding from sending a scheduling grant to the UE during a particular subframe and transmitting a scheduling grant to the UE in one of an odd or an even subframe for informing the UE 10 the selected one of the two Tx antennas.

In the foregoing exemplary embodiments it should be appreciated that the antenna can also be indicated based on subframe number by applying a modulo operation to the subframe number, with the modulus corresponding to the number of antennas. In other words, Tx=Sf mod Nt, where Tx is antenna number 0, 1, . . . , Nt; Sf is the subframe number; and Nt is number of antennas. When the number of subframes is not a multiple of Nt, it may be desirable to replace the subframe number with a number derived from the subframe and frame numbers, e.g., with a number Sf+SF*(f-1) where Sf is the subframe number, SF is the number of subframes in a frame, and f is the frame number.

Note that there is no need to make a linkage to the sounding RS (or other channel sounding method).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Various modifications and adaptations to the foregoing exemplary embodiments of this invention may become apparent to those skilled in the relevant arts in view of the foregoing description, when read in conjunction with the accompanying drawings. For example, the exemplary embodiments are not limited for use with only two Tx antennas at the UE 10. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
determining a characteristic related to a receipt of a resource allocation in a particular subframe; and
based on the determined characteristic, selecting one of a plurality of transmit antennas for use in transmitting to a wireless network node.

2. The method of claim 1, wherein the characteristic related to the receipt of the resource allocation comprises whether another resource allocation was received in an immediately preceding subframe, and if another resource allocation was not received in an immediately preceding subframe, then selecting a transmit antenna that was used to transmit a last sounding reference signal to the wireless network node.

3. The method of claim 1, wherein the resource allocation is a resource allocation for new data.

4. The method of claim 1, wherein the characteristic related to the receipt of the resource allocation comprises whether another resource allocation was received in an immediately preceding subframe, and if another resource allocation was not received in an immediately preceding subframe, whether the resource allocation was received in an even numbered subframe or in an odd numbered subframe, where selecting selects a first transmit antenna if the resource allocation was received in an even numbered subframe and selects a different transmit antenna if the resource allocation was received in an odd numbered subframe.

5. The method of claim 1, executed at least in part by a data processor that comprises part of a user equipment, wherein the resource allocation comprises a scheduling grant received from a base station.

6-31. (canceled)

32. An apparatus, comprising:
at least one wireless receiver configurable to receive a resource allocation from a wireless network node; and
a controller configurable to determine a characteristic related to a receipt of a resource allocation in a particular subframe and, based on the determined characteristic, to select one of a plurality of transmit antennas for use in transmitting to the wireless network node.

33. The apparatus of claim 32, wherein the characteristic related to the receipt of the resource allocation comprises whether another resource allocation was received in an immediately preceding subframe, and if another resource allocation was not received in an immediately preceding subframe, then said controller selects a transmit antenna that was used to transmit a last sounding reference signal to the wireless network node.

34. The apparatus of claim 32, wherein the resource allocation is a resource allocation for new data.

35. The apparatus of claim 32, wherein the characteristic related to the receipt of the resource allocation comprises whether another resource allocation was received in an immediately preceding subframe, and if another resource allocation was not received in an immediately preceding subframe, whether the resource allocation was received in an even numbered subframe or in an odd numbered subframe, wherein said controller selects a first transmit antenna if the resource allocation was received in an even numbered subframe and selects a different transmit antenna if the resource allocation was received in an odd numbered subframe.

36. The apparatus of claim 32, embodied in a user equipment, wherein the resource allocation comprises a scheduling grant received from a base station,

37. A method, comprising:
receiving during subframes reference signals transmitted from different ones of a plurality of transmit antennas of a user equipment; and
signaling to the user equipment an identification of one of the plurality of transmit antennas to be used for a next transmission, wherein signaling comprises selecting the transmit antenna based at least on the received reference signals, withholding sending a resource allocation to the user equipment during a particular subframe, and transmitting a resource allocation to the user equipment in a particular subframe, wherein the number of the particular subframe specifies which one of the plurality of transmit antennas is to be used by the user equipment for a next transmission.

38. The method of claim 37, wherein if the particular subframe number is odd then a particular one of the transmit antennas is specified, and if the particular subframe number is even then a different particular one of the transmit antennas is specified.

39. The method of claim 37, wherein the resource allocation is a scheduling grant transmitted from a base station.

40. The method of claim 37, wherein the resource allocation is a resource allocation for new data.

41. The method of claim 37, executed at least in part by a data processor that comprises part of a base station, wherein the resource allocation comprises a scheduling grant.
